(19) United States
(12) Patent Application Publication
(10) Pub. No.: US 2026/0152347 A1
(43) Pub. Date: Jun. 4, 2026

(54) Article Transport Facility

(71) Applicant: Daifuku Co., Ltd., Osaka-shi (JP)

(72) Inventors: Takahiro Yamaguchi, Hinocho (JP); Koichi Hagiwara, Komaki-shi (JP); Makoto Kono, Komaki-shi (JP); Tomoaki Nishikawa, Hinocho (JP); Kosuke Sakamoto, Hinocho (JP)

(21) Appl. No.: 19/399,886

(22) Filed: Nov. 25, 2025

(30) Foreign Application Priority Data
Dec. 2, 2024 (JP) 2024-209677

(51) Int. Cl. B65G 1/137; B65G 1/04

(52) U.S. Cl. CPC B65G 1/137; B65G 1/0457; B65G 2201/02; B65G 2203/0208

(57) ABSTRACT

An article transport facility includes a travelable path divided into multiple areas. A controller performs, in response to the areas including a high-density area having a higher density of movable bodies than another area among the areas, distribution control to change a destination of at least one movable body to an escape destination to reduce a density of movable bodies in the high-density area. In the distribution control, the controller sets, in response to target movable bodies in the high-density area including a transporting movable body transporting an article toward a transfer destination outside the high-density area to transfer the article, the escape destination of the transporting movable body inside an area, among the areas, closer to the transfer destination than the high-density area.

### CROSS-REFERENCE TO RELATED APPLICATION

This application claims priority to Japanese Patent Application No. 2024-209677 filed Dec. 2, 2024, the disclosure of which is hereby incorporated by reference in its entirety.

### BACKGROUND OF THE INVENTION

### Field of the Invention

The present invention relates to an article transport facility.

### Description of Related Art

Japanese Patent No. 7439789 describes an article transport facility including multiple movable bodies that move along a predetermined travelable path to transport articles. Each movable body, which moves along the predetermined path, may undergo deceleration, stop, or other restriction of movement in a travel direction when, for example, another movable body is ahead. When many movable bodies concentrate in a specific area of the path, in particular, congestion occurs and affects many movable bodies passing the area. Japanese Patent No. 7439789 describes distribution of standby movable bodies that are not intended to pick up or transfer articles across the entire travelable path. This technique can avoid high density of movable bodies caused by concentration of such standby movable bodies in a specific area, thus reducing the likelihood of, for example, congestion.

### SUMMARY OF THE INVENTION

Movable bodies included in an area with high-density movable bodies are not limited to standby movable bodies. Movable bodies transporting articles to a transfer place or traveling to pick up articles may also increase the density of movable bodies in a specific area. Thus, the movable bodies to be distributed may include movable bodies other than standby movable bodies. However, movable bodies may be moved to positions far from their destinations through the distribution. In this case, although the movable bodies can avoid lowering the travel speed in the congested area, the individual movable bodies may move longer distances, thus possibly increasing the transport time in the entire facility. In other words, the reduction in partial congestion may rather lower the transport efficiency or limit the improvement in transport efficiency.

In response to the above, one or more aspects are directed to appropriately distributing movable bodies to improve the travel efficiency that may be lowered due to concentration of the movable bodies, and to improve the transport efficiency of the entire facility.

An article transport facility in response to the above includes a plurality of movable bodies each movable along a travelable path to transport an article, and a controller that assigns, to each of the plurality of movable bodies, a task for which a destination is specified and controls the plurality of movable bodies. The travelable path is divided into a plurality of areas. The controller performs, in response to the plurality of areas including a high-density area having a higher density of movable bodies than another area among the plurality of areas, distribution control to change the destination of at least one of the plurality of movable bodies to an escape destination to reduce a density of movable bodies in the high-density area. In the distribution control, the controller sets, in response to a plurality of target movable bodies that are the movable bodies in the high-density area including a transporting movable body transporting the article toward a transfer destination outside the high-density area to transfer the article, the escape destination of the transporting movable body inside an area, among the plurality of areas, closer to the transfer destination than the high-density area.

This structure can reduce, through the distribution control, the density of movable bodies in the high-density area and reduce congestion or other factors that interfere with traveling of movable bodies. For the transporting movable body having the transfer destination already determined, the escape destination is set inside another area closer to the transfer destination than the high-density area. This avoids lowering the transport efficiency of the entire facility through the distribution control. The above structure can thus appropriately distribute movable bodies to improve the travel efficiency that may be lowered due to concentration of the movable bodies, and to improve the transport efficiency of the entire facility.

Further features and advantageous effects of the article transport facility will be apparent from exemplary and nonlimiting embodiments described below with reference to the drawings.

### BRIEF DESCRIPTION OF THE DRAWINGS

FIG. 1 is a schematic diagram of a travelable path in an article transport facility.

FIG. 2 is a side view of a ceiling-hung transport vehicle.

FIG. 3 is a schematic control block diagram of the article transport facility.

FIG. 4 is a diagram showing example escape destinations in distribution control.

FIG. 5 is a diagram showing priorities with which movable bodies are moved in the distribution control.

FIG. 6 is a schematic block diagram of a contactless power feeder included in the article transport facility, showing its system configuration.

FIG. 7 is a flowchart of example distribution control.

### DESCRIPTION OF THE INVENTION

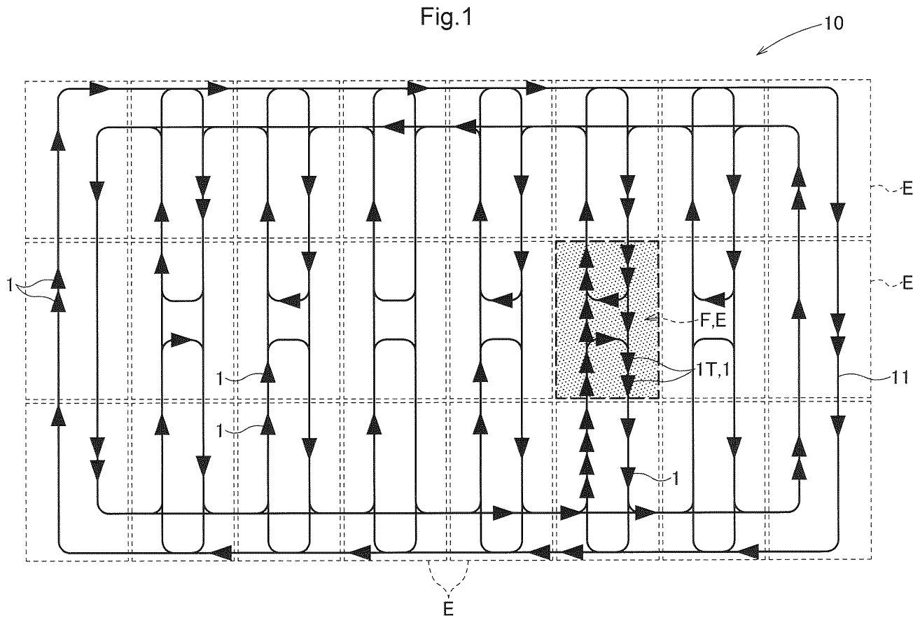

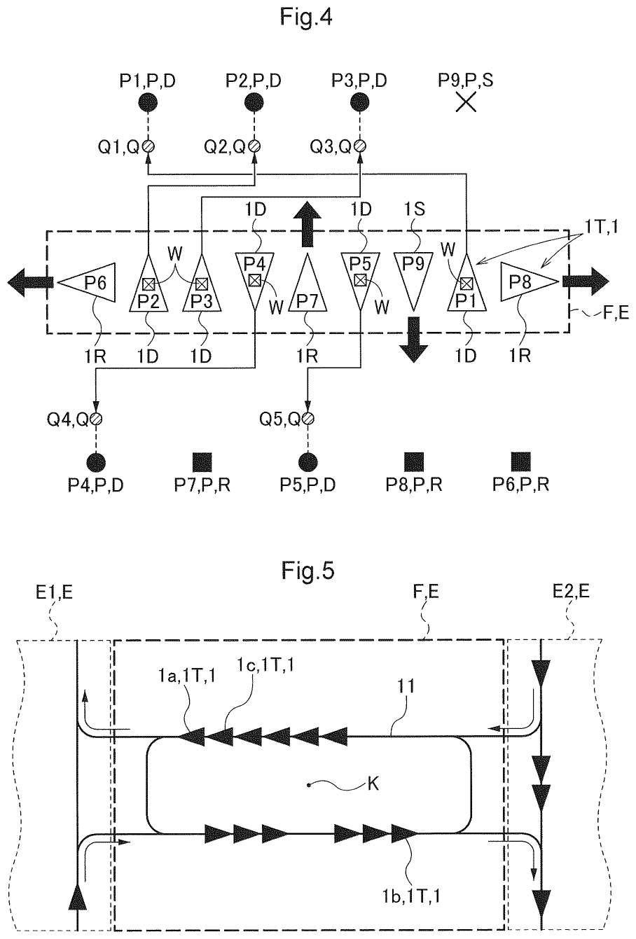

An article transport facility according to an embodiment will now be described below with reference to the drawings. FIG. 1 schematically shows a travelable path 11 in an article transport facility 10 including multiple movable bodies 1 that move along the travelable path 11 to transport articles W (refer to FIG. 4). The movable bodies 1 travel in a predetermined direction. As shown in FIG. 1, in the article transport facility 10, the entire travelable path 11 is divided into multiple areas E.

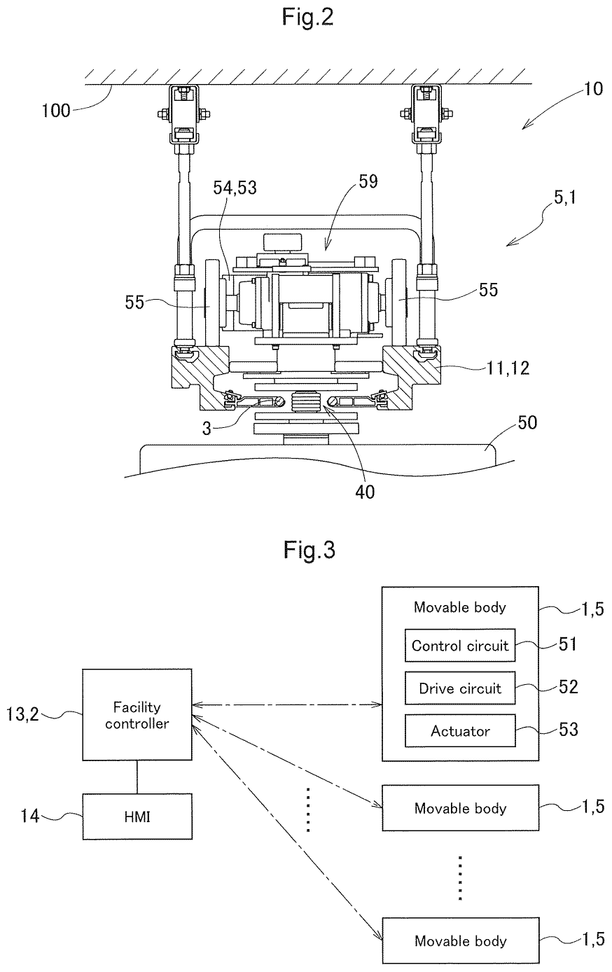

In the present embodiment, as shown in FIG. 2, a ceiling-hung transport vehicle 5 is used as an example of a movable body 1 that is an article transport vehicle to transport articles W. The ceiling-hung transport vehicle 5 transports articles W while moving along travel rails 12 hung from a ceiling 100 of the building that serve as the travelable path 11. The ceiling-hung transport vehicle 5 includes a traveler 59, a transport vehicle body 50, and a power receiver 40. The traveler 59 travels along the travelable path 11 as guided by the travel rails 12 as a pair hung from the ceiling 100. The transport vehicle body 50 is below the travel rails 12 and hung from the traveler 59. The power receiver 40 receives driving power contactlessly from feed lines 3 installed along the travelable path 11. The transport vehicle body 50 includes an article support (not shown) that is raised or lowered to support an article W being hung. The article to be transported by the ceiling-hung transport vehicle is, for example, a front opening unified pod (FOUP) containing semiconductor substrates or a glass substrate for a display.

The traveler 59 includes a pair of travel wheels 55 that are rotated by a drive motor 54 (actuator 53). The travel wheels 55 roll on travel surfaces defined by the upper surfaces of the travel rails 12. The traveler 59 includes, for example, the drive motor 54 for traveling and a drive circuit 52 (refer to FIG. 3) for the drive motor 54 to allow the ceiling-hung transport vehicle 5 to travel along the travel rails 12. The transport vehicle body 50 includes, for example, an actuator 53 that drives a lifter for raising and lowering the article support, an actuator 53 that drives grippers for gripping articles, and drive circuits 52 for these actuators.

Power for the drive motor 54, the actuators 53, and the drive circuits 52 for these components is supplied contactlessly from the feed lines 3 to the power receiver 40. In the present embodiment, the power receiver 40 uses a wireless power feed technique to receive power from the feed lines 3 and supply driving power to the ceiling-hung transport vehicle 5. The feed lines 3 as induction lines carry high-frequency current and generate a magnetic field around the feed lines 3. The power receiver 40 includes a pickup coil and a magnetic core. The pickup coil induces power with electromagnetic induction from the magnetic field. The induced alternating current (AC) power is converted to direct current power by a power receiver circuit (not shown) including, for example, a rectifier such as a full-wave rectifier and a smoothing capacitor, and is supplied to the actuators 53 and the drive circuit.

FIG. 3 is a schematic control block diagram of the article transport facility 10. The article transport facility 10 includes a controller 2 that assigns, to each ceiling-hung transport vehicle 5 (movable body 1), a task for which a destination P (refer to FIG. 4) is specified and controls the ceiling-hung transport vehicles 5. In the present embodiment, the controller 2 includes a facility controller 13 as its core of the controller 2. Each ceiling-hung transport vehicle 5 includes a control circuit 51 that controls the ceiling-hung transport vehicle 5, a drive circuit 52 that drives the actuators 53 based on the control performed by the control circuit 51, and the actuators 53 that drive machinery components (e.g., the travel wheels 55, the grippers, and the lifter). The control circuit 51 includes a communicator that can communicate with at least the facility controller 13. The communicator may further communicate with other ceiling-hung transport vehicles 5.

Each ceiling-hung transport vehicle 5 includes a reader (not shown) that reads information from positional information (e.g., a one-or two-dimensional barcode or a radio frequency identification (RFID) chip) disposed at, for example, the travel rails 12. The control circuit 51 obtains the positional information read by the reader. Each ceiling-hung transport vehicle 5 thus identifies its positional information on the travelable path 11. Each ceiling-hung transport vehicle 5 transmits its positional information to the facility controller 13. The facility controller 13 thus obtains the positional information of each ceiling-hung transport vehicle 5 associated with identification information of the corresponding ceiling-hung transport vehicle 5. In other words, the facility controller 13 identifies the positions of all the ceiling-hung transport vehicles 5 on the travelable path 11, and assigns, to each ceiling-hung transport vehicle 5, a task for which a destination P is specified.

The destination P is, for example, a pickup destination R, a transfer destination D, or a standby destination S. The pickup destination R is a position at which an unloaded ceiling-hung transport vehicle 5 picks up an article W. The transfer destination D is a position at which a ceiling-hung transport vehicle 5 loaded with an article W transfers the article W. The standby destination S is a standby position at which a ceiling-hung transport vehicle 5 is left on standby. The facility controller 13 transmits a task to each ceiling-hung transport vehicle 5 based on the position of the ceiling-hung transport vehicle 5 and other factors. The task is, for example, a pickup task of picking up an article W, a transport task of transporting a picked-up article W, or a standby task of leaving the ceiling-hung transport vehicle 5 on standby. Other tasks may include an expelling task of moving a ceiling-hung transport vehicle 5 from a travel path to be traveled by another ceiling-hung transport vehicle 5 (expelling from the current position) not to interfere with the other ceiling-hung transport vehicle 5. The expelling task may be performed as the standby task.

A ceiling-hung transport vehicle 5 transports an article W after picking up the article W. The ceiling-hung transport vehicle 5 may concurrently receive instructions for the pickup task and the transport task and then sequentially perform the pickup task and the transport task. In this manner, multiple tasks may be concurrently assigned. Multiple tasks to be sequentially performed may be assigned concurrently, or may be assigned at an interval. For example, the ceiling-hung transport vehicle 5 during a transfer task may be assigned with a pickup task to be performed after the transfer of the article W.

In the pickup task, a ceiling-hung transport vehicle 5 receives information about the pickup destination R and the travel path from the current position of the ceiling-hung transport vehicle 5. The ceiling-hung transport vehicle 5 (movable body 1) assigned with the pickup task is referred to as a pickup-directed movable body 1R. In the transfer task, a ceiling-hung transport vehicle 5 receives information about the transfer destination D and the travel path from the current position of the ceiling-hung transport vehicle 5. The ceiling-hung transport vehicle 5 (movable body 1) assigned with the transfer task is referred to as a transporting movable body 1D. In the standby task, a ceiling-hung transport vehicle 5 receives information about the standby destination S indicating a standby position and the travel path from the current position of the ceiling-hung transport vehicle 5. The ceiling-hung transport vehicle 5 (movable body 1) assigned with the standby task is referred to as a standby-directed movable body 1S. The ceiling-hung transport vehicle 5 stopped at the standby destination S after arriving at the standby destination S is referred to as a standby movable body.

In the present embodiment, the facility controller 13 functions as a master controller or a primary controller. The control circuit 51 in each ceiling-hung transport vehicle 5 functions as a client controller or a secondary controller. More specifically, the facility controller 13 substantially functions as the controller 2. In some embodiments, the facility controller 13 and the control circuit 51 in each ceiling-hung transport vehicle 5 may work in cooperation to form a single controller 2 (control system) with grid computing. In some embodiments, the facility controller 13 may be eliminated, and the control circuits 51 in the ceiling-hung transport vehicles may work in cooperation to form a single controller 2 (control system) with grid computing.

Each movable body 1, which moves along the travelable path 11 as a predetermined path, may undergo deceleration, stop, or other restriction of movement in a travel direction when, for example, another movable body 1 is ahead. When many movable bodies 1 concentrate in a specific area E, in particular, congestion occurs and affects many movable bodies 1 passing the area E. When many movable bodies 1 concentrate in a specific area E, or in other words, when the specific area E has a high density of movable bodies 1, the movable bodies 1 may be distributed to other areas E to reduce the density of movable bodies 1 in the area E.

In the present embodiment, when the multiple areas E include a high-density area F (refer to FIG. 1) that is an area E having a higher density of movable bodies 1 than other areas E, the controller 2 performs distribution control to change the destination P of at least one movable body 1 to an escape destination (a relocated destination) Q to reduce the density of movable bodies 1 in the high-density area F.

However, movable bodies 1 may be moved to positions far from their destinations P through the distribution. In this case, although the movable bodies 1 can avoid lowering the travel speed in the congested specific area E, the individual movable bodies 1 may move longer distances before reaching the destinations P, thus possibly increasing the transport time in the entire facility. In other words, the reduction in partial congestion may rather lower the transport efficiency or limit the improvement in transport efficiency.

Thus, in the article transport facility 10 according to the present embodiment, the controller 2 sets a different escape destination for each movable body 1 as a destination in the distribution control based on the attribute of the movable body 1 (e.g., the task assigned to the movable body 1). In the distribution control, the controller 2 sets, in response to target movable bodies 1T that are the movable bodies 1 in the high-density area F including a transporting movable body 1D that is a movable body 1 transporting an article W toward the transfer destination D outside the high-density area F to transfer the article W, the escape destination Q of the transporting movable body 1D to a point in another area E closer to the transfer destination D than the high-density area F. The details are described later with reference to, for example, FIG. 4.

The target movable bodies 1T include movable bodies 1 in first to third categories below. A target movable body 1T in the first category is a movable body 1 inside the high-density area F and having the destination P of a task inside the high-density area F. A target movable body 1T in the second category is a movable body 1 inside the high-density area F and having the destination P of a task outside the high-density area F. A target movable body 1T in the third category is a movable body 1 inside the high-density area F and having no destination P for movement. The movable body 1 in the third category is, for example, a movable body 1 having the standby destination S inside the high-density area F and for which the standby destination S is cleared upon completion of movement in a standby task when the movable body 1 arrives at the standby destination S. The target movable bodies 1T may be movable bodies 1 in one or two of the first category, the second category, and the third category. For example, the movable body 1 in the first category (the movable body 1 inside the high-density area F and having the destination P inside the high-density area F) may be excluded from the target movable bodies 1T. When such a movable body 1 in the first category assigned with a particular task, such as a transporting movable body 1D, is relocated from the high-density area F, the transport efficiency may be lowered.

FIG. 4 shows, among the movable bodies 1 (target movable bodies 1T) included in the high-density area F, nine movable bodies 1 to be moved to areas E other than the high-density area F. P1 to P9 associated with the movable bodies 1 indicate the destinations P based on the tasks assigned to the respective movable bodies 1. Five points P1 to P5 indicate transfer destinations D, three points P6 to P8 indicate pickup destinations R, and P9 indicates a standby destination S. Five movable bodies 1 having the transfer destinations D as the destinations P are transporting movable bodies 1D. Three movable bodies 1 having the pickup destinations R as the destinations P are pickup-directed movable bodies 1R. One movable body 1 having the standby destination S is a standby-directed movable body 1S.

For the five transporting movable bodies 1D among the nine target movable bodies 1T, escape destinations Q are set to points in other areas E closer to the respective transfer destinations D than the high-density area F. More specifically, the respective escape destinations Q are a point Q1 closer to P1, a point Q2 closer to P2, a point Q3 closer to P3, a point Q4 closer to P4, and a point Q5 closer to P5. The term closer herein is based on the movement distance along the travelable path 11 between the escape destination Q and the transfer destination D, rather than based on the distance in a straight line. The area E including the each escape destination Q may be the same as the area E including the transfer destination D corresponding to the escape destination Q. Each escape destination Q may be the same points as the transfer destination D corresponding to the escape destination Q.

For the four movable bodies 1, or specifically, the three pickup-directed movable bodies 1R and the standby-directed movable body 1S among the nine target movable bodies 1T, the escape destinations Q are set to be distributed across the entire travelable path 11 independently of the destinations P (pickup destinations R and standby destination S) of these movable bodies 1.

However, when the pickup-directed movable bodies 1R and the standby-directed movable body 1S move toward their original destinations P after the distribution control, the movement distance and the travel time of these movable bodies 1 may be increased. With no articles W on the pickup-directed movable bodies 1R or the standby-directed movable body 1S, any of these movable bodies 1 may be selected to travel to the pickup destination R. For the pickup-directed movable bodies 1R and the standby-directed movable body 1S, the pickup destinations R and the standby destination S may be cancelled. Cancelling the destinations P causes the tasks assigned to these movable bodies 1 to remain unfinished, and is thus equivalent to cancelling the tasks.

In the distribution control, the controller 2 may cancel the tasks assigned to the movable bodies 1 other than the transporting movable bodies 1D among the target movable bodies 1T. In the distribution control, the controller 2 may cancel at least pickup tasks assigned to the pickup-directed movable bodies 1R that are movable bodies 1 moving toward the pickup destinations R to pick up articles W.

After the distribution control, the controller 2 causes the movable bodies 1 to perform their normal tasks. The controller 2 causes the movable bodies 1 to resume their tasks assigned before the start of the distribution control. The transporting movable bodies 1D, for which the escape destinations Q have been set closer to the transfer destinations D, can promptly end the transfer tasks. For the movable bodies 1 other than the transporting movable bodies 1D, the escape destinations Q may be far from their destinations P. However, as described above, the tasks of the movable bodies 1 other than the transporting movable bodies 1D can be cancelled, and such movable bodies 1 can be reassigned with tasks based on their current positions (escape destinations Q). This allows the movable bodies 1 to end their tasks promptly.

More specifically, after the distribution control, the controller 2 may cause the transporting movable bodies 1D to continue their tasks (transfer tasks) and move toward their transfer destinations D, and may reassign tasks (e.g., pickup tasks) to the movable bodies 1 other than the transporting movable bodies 1D.

As described above with reference to FIG. 4, the movable bodies 1 to be moved from the high-density area F include movable bodies 1 with various attributes, such as the transporting movable bodies 1D, the pickup-directed movable bodies 1R, and the standby-directed movable bodies 1S. The movable bodies 1 (escape movable bodies (relocation movable bodies)) to be moved from the high-density area F and distributed may be selected based on their attributes, or may be selected based on ease of movement independently of the attributes.

As described below with reference to FIG. 5, in the distribution control, the controller 2 may preferentially cause, for example, a target movable body 1T, among the multiple target movable bodies 1T, farther from a center K of the high-density area F to start moving, as a movable body 1 to be distributed (escape movable body). FIG. 5 shows a high-density area F, and a first area E1 and a second area E2 adjacent to the high-density area F. Each of the first area E1 and the second area E2 is not a high-density area F. In this example, portions of the high-density area F farther from the center K are closer to the exit to the first area E1 adjacent to the high-density area F and closer to the exit to the second area E2 adjacent to the high-density area F. The distance between each movable body 1 and the corresponding exit is based on the movement distance along the travelable path 11, rather than based on the distance in a straight line. The movable body 1 closest to the first area E1 among the target movable bodies 1T is a first movable body 1a. The movable body 1 closest to the second area E2 among the target movable bodies 1T is a second movable body 1b.

The first movable body 1a is closer to an adjacent area E than the second movable body 1b. Thus, the first movable body 1a is at a position that allows easier exit from the high-density area F. The controller 2 thus moves the first movable body 1a with the first priority. When the distance between the first movable body 1a and the first area E1 is equal (substantially equal) to the distance between the second movable body 1b and the second area E2, or in other words, when these movable bodies are at an equal distance from adjacent areas E, a higher priority is given to the movable body 1 belonging to a line (a group of movable bodies 1 traveling in the same direction) including more movable bodies. In the example in FIG. 5, the line including the first movable body 1a has six movable bodies. The line including the second movable body 1b may be referred to as having three movable bodies. In this case, a higher priority is given to the first movable body 1a. The line including the second movable body 1b may also be referred to as having six movable bodies. In this case, a higher priority may be given to the movable body 1 belonging to the line with a shorter distance (line length or group length) between the leading movable body 1 and the trailing movable body 1 in the line. With the same number of movable bodies included in lines, the shorter line has higher density.

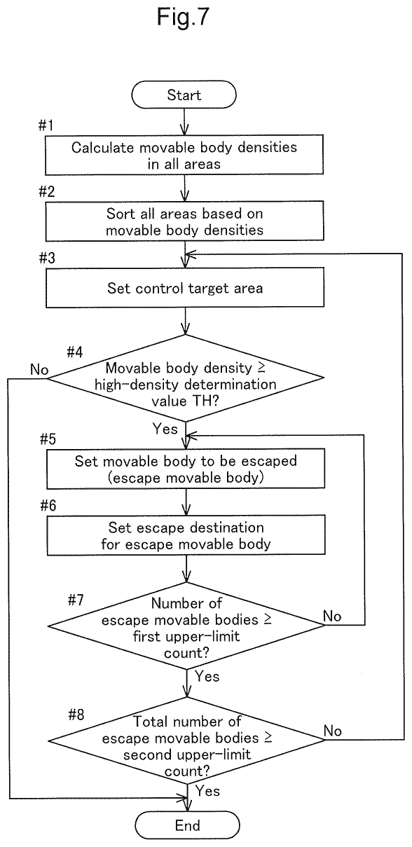

In the priority order determined in this manner, the escape movable bodies to be distributed are selected until the number of selected movable bodies reaches the number of movable bodies to be moved from the high-density area F (first upper-limit count described later). The escape movable bodies then start moving to the escape destinations Q (corresponding to steps #5, #6, and #7 described later with reference to FIG. 7). In the example in FIG. 5, the controller 2 causes the first movable body 1a, the second movable body 1b, and a third movable body 1c to start moving in this order.

When a movable body 1 that is close to an adjacent area E, such as the first movable body 1a or the second movable body 1b, is a transporting movable body 1D and its transfer destination D is inside the high-density area F including the transporting movable body 1D, the transporting movable body 1D may remain in the high-density area F. In this case, however, the transporting movable body 1D (first movable body 1a) may block the path of other movable bodies 1, which cannot exit the high-density area F. In such a case, the transporting movable body 1D may be given a escape destination Q and controlled to exit to an area E other than the high-density area F and then return to, after the distribution control, its original area E that is no longer a high-density area F.

Movement of the movable bodies 1 in the high-density area F (target movable bodies 1T) may involve movement or stop (temporary stop) of movable bodies 1 in another area E, other than the target movable bodies 1T. The movement includes temporary movement to, for example, a sidetrack to give way. The temporary stop includes a suspension of a task assigned to each movable body 1. Thus, the distribution control is not limited to direct movement for reducing the movable body density in the high-density area F. Rather than simply controlling the movable bodies 1 (target movable bodies 1T) in the high-density area F, the distribution control may control all the movable bodies 1.

The areas E for which the density of movable bodies 1 is determined may correspond to areas defined for a function different from the travelable path 11 in the article transport facility 10. For example, the areas E may correspond to areas (feed areas Z described later) in a feed system using the above feed lines 3.

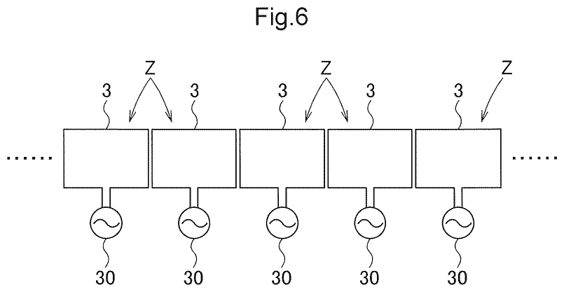

As shown in FIG. 6, each feed line 3 includes a power supply 30 to supply AC to the feed line 3. The power supply 30 supplies high-frequency current to the feed line 3 as an induction line to generate a magnetic field around the feed line 3. A longer travelable path 11 in the article transport facility 10 may involve longer feed lines 3 along the travelable path 11. Such longer feed lines 3 have a greater resistance of the conducting wires and may lower the power transmission efficiency. Longer feed lines 3 may supply power to more ceiling-hung transport vehicles 5 and thus increase the load on the power supplies 30 (refer to FIG. 6) that supply power to the feed lines 3. Any abnormality in the feed system, such as disconnection or short-circuiting of the feed lines 3 or failure of the power supplies 30, may stop the entire feed system and thus stop the entire article transport facility 10. The article transport facility 10 thus includes multiple feed systems including the feed lines 3 and the power supplies 30 as shown in FIG. 6, rather than a single feed system. The feed lines 3 are installed along the travel rails 12 (travelable path 11). The areas for the respective feed systems arranged along the travelable path 11 are the feed areas Z.

The ceiling-hung transport vehicles 5 switch the multiple feed systems one from another and continuously receive power to travel in the article transport facility 10. For smooth traveling of the ceiling-hung transport vehicles 5, the AC in the multiple feed systems is adjusted to be in phase for stable power supply at the junctions of the feed areas Z (feed systems), or in other words, at the junctions of the feed lines 3.

An increased number of movable bodies 1 included in each feed area Z consume more power and increase the load on the power supply 30. Power consumption exceeding the supply from the power supply 30 may cause malfunctions such as voltage drops. The number of movable bodies 1 in each feed area Z is thus to be limited. The number of movable bodies 1 in each area E and the number of movable bodies 1 in each feed area Z may be managed, with the areas E and the feed areas Z matching. In this case, the smaller one of the limited number in each area E based on the movable body density and the limited number in each feed area Z based on the power feeding capability may be used as the limited number.

A method for determining whether each area is a high-density area F will now be described. The controller 2 sets, for each area E, a limited number Nlim that is the upper-limit count as a maximum number of movable bodies 1 allowed to be in the area E. The controller 2 calculates, for each area E, a ratio Nt/Nlim of a target count Nt of movable bodies 1 substantially in the area E to the limited number Nlim. The ratio is referred to as the density of movable bodies 1 in each area E. The controller 2 determines, as a high-density area F, an area E in which the density of movable bodies 1 is greater than or equal to a predetermined high-density determination value TH.

The target count Nt for each area E is the sum of the number of movable bodies 1 inside the area E and having the destination P inside the area E and the number of movable bodies 1 outside the area E and having the destination P inside the area E. In other words, the number of movable bodies 1 substantially in each area E is the sum of the number of movable bodies 1 currently stopped in the area E and the number of movable bodies 1 expected to be stopped in the area E in the immediate future. The target count Nt may be the sum of the number of movable bodies 1 in the area E having any destination P and the number of movable bodies 1 outside the area E and having the destination P inside the area E.

With reference to the flowchart in FIG. 7, an example of the distribution control will now be described. In the present embodiment, the distribution control is performed in response to an instruction from an administrator of the article transport facility 10. As shown in FIG. 3, a human-machine interface (HMI) 14 is connected to the facility controller 13. The HMI 14 may include a display, an input device (e.g., a keyboard and a mouse), and a mobile terminal carried by the administrator. For example, the display displays the movable bodies 1 on the travelable path 11 shown in FIG. 1. The administrator refers to the display to identify, for example, congestion. When the administrator determines to adjust the positions of the movable bodies 1, or in other words, to distribute the movable bodies 1 from a congested area E, the administrator operates the input device or the mobile terminal to provide an instruction to start the distribution control. The controller 2 starts the distribution control in response to the instruction from the administrator.

In the distribution control, first, the controller 2 calculates the movable body densities (Nt/Nlim) in all the areas E in the article transport facility 10 (#1). The controller 2 then sorts all the areas E based on the movable body densities. More specifically, the controller 2 lists the areas E in descending order of the movable body density (#2). For areas E with the same movable body density, the order is determined under a predetermined condition based on the limited number Nlim for the areas E. For example, a higher order is given to the area E with a smaller limited number to emphasize avoidance of congestion in the area E that is more likely to exceed the limited number. In some embodiments, a higher order may be given to the area E with a greater limited number to emphasize a larger number of movable bodies 1 to be relocated. For areas E with the same movable body density (Nt/Nlim), a greater limited number Nlim as a denominator indicates that more movable bodies 1 are to be moved to reduce the movable body density by substantially the same degree. For areas E with the same limited number as well, the order may be determined based on an index independent of the movable body density, such as the position of the area E (whether the position is more likely to be congested) or an identification number.

Steps #1 and #2 may be referred to as a preprocess in the distribution control. The process in step #3 and subsequent steps may be referred to as a main process in the distribution control as distinguished from the preprocess.

The preprocess may be periodically performed independently of whether an instruction for the distribution control is provided. This allows prompt start of the main process in response to an instruction to start the distribution control. The display may display the travelable path 11 with the areas E color-coded based on the movable body density using the calculation results obtained in step #1 in the preprocess. This allows the administrator to more objectively determine whether to perform the distribution control.

In the main process, the controller 2 sets a control target area of the distribution control (#3). More specifically, the controller 2 sets the area E with the highest movable body density as a control target area based on the sorting results obtained in step #2. The controller 2 also temporarily stops (suspends) the tasks (particularly, transfer tasks and pickup tasks) performed by all the movable bodies 1 in the article transport facility 10. When the area to be controlled for transporting articles in the article transport facility 10 is divided into subareas, the tasks performed by all the movable bodies 1 within each subarea, or specifically, within the range of the travelable path 11 subjected to the distribution control are temporarily stopped (suspended). The controller 2 executes the instruction to temporarily stop (suspend) the tasks before the start of the distribution control, or specifically at least before the start of the main process.

The controller 2 then determines whether the movable body density in the control target area is greater than or equal to the high-density determination value TH (#4). When determining that the movable body density is less than the high-density determination value TH in step #4, the controller 2 does not move the movable bodies 1 from the control target area and ends the distribution control.

When determining that the movable body density is greater than or equal to the high-density determination value TH in step #4, the controller 2 sets a movable body 1 (escape movable bodies (relocation movable body)) to be distributed (to be relocated) as described above with reference to, for example, FIG. 5 (#5). The controller 2 then sets a escape destination Q for the escape movable body as described above with reference to FIG. 4 (#6). The movable body 1 starts traveling toward the destination P upon the setting of the destination P. In other words, the controller 2 concurrently sets the destination P for the movable body 1 and instructs the movable body 1 to start traveling. When all the areas E are sorted in order of the movable body density as in the present embodiment, the escape destination Q may be set preferentially to an area E with a lower movable body density. In some embodiments, the escape destination Q may be set to any area E other than a high-density area F, independently of the density.

The escape movable body and the escape destination Q for the escape movable body are repeatedly set until the number of set escape movable bodies reaches the first upper-limit count (#5, #6, and #7). When the number of escape movable bodies is smaller than the first upper-limit count in step #7, the processing returns to step #5. Another movable body 1, different from the movable bodies 1 already assigned with escape destinations Q, is set as a new escape movable body (#5). For this escape movable body, a escape destination Q is set (#6).

The first upper-limit count may be based on the difference between the limited number Nlim and the target count Nt that are used to calculate the movable body density Nt/Nlim for determining whether the distribution control is to be performed. For example, the first upper-limit count is defined by Nt−Nlim+A, where A is a constant. In this formula, A is an offset value (constant), and a positive integer greater than zero. The offset value A, which is a natural number, is set to reduce the movable body density in the high-density area F to a level far below the limit, rather than to a level immediately below the limit. The value of Nt−Nlim is positive when the high-density determination value TH as a determination index in step #4 is greater than 1, and is negative when the high-density determination value TH is smaller than 1. The offset value A may be a value that allows the first upper-limit count to be positive when the high-density determination value TH is smaller than 1. In the present embodiment, the values Nlim and Nt may each be different for different areas E, and the first upper-limit count is thus variable. In some embodiments, the values Nlim and Nt may each be the same for all the areas E, and the first upper-limit count may be fixed.

When the number of escape movable bodies has reached the first upper-limit count in step #7, the main process in the distribution control for the control target area is complete. The controller 2 then determines whether the total number of escape movable bodies is smaller than a second upper-limit count (#8). The second upper-limit count is greater than the first upper-limit count. When determining that the total number of escape movable bodies is smaller than the second upper-limit count in step #8, the controller 2 returns to step #3 and sets a control target area. When determining that the total number of escape movable bodies is greater than or equal to the second upper-limit count in step #8, the controller 2 ends the distribution control. The distribution control may be ended in response to an instruction from the administrator provided through the HMI 14, independently of the determination result in step #8, as well as the distribution control started in response to an instruction from the administrator as described above.

The total number of escape movable bodies refers to the total number of movable bodies 1 that are set as the escape movable bodies during the distribution control (main process) and that have exited from the control target area(s). When the distribution control (main process) has been performed on a single control target area before step #8, the number of escape movable bodies in this control target area is the total number of escape movable bodies. When the distribution control (main process) has been performed on multiple control target areas before step #8, the sum of the numbers of escape movable bodies in the respective control target areas is the total number of escape movable bodies.

As described above, the controller 2 in the distribution control temporarily stops the tasks (particularly, transfer tasks and pickup tasks) performed by all the movable bodies 1 in the article transport facility 10 (within the range of the travelable path 11 subjected to the distribution control). In other words, the transport of the articles W is suspended during the distribution control. When the suspension time lasts long, the transport efficiency of the entire article transport facility 10 may be lowered, although issues associated with the high-density area F are reduced. Thus, the time for the distribution control per cycle (per processing cycle from the start to the end in FIG. 7) is limited. The second upper-limit count is used to restrict the duration of the distribution control. The second upper-limit count is based on the time allowed for the suspension of transport of the articles W. The second upper-limit count is a predetermined value.

When determining that the total number of escape movable bodies is smaller than the second upper-limit count, the controller 2 returns to step #4 to set, as the control target area, another area E with the second highest movable body density behind the area E from which the movable bodies 1 have been relocated most recently. The controller 2 performs the processing in steps #4, #5, #6, and #7 as described above.

Step #8 is performed after the distribution control on the control target area is complete (after step #7). In step #7, the number of escape movable bodies is compared with the first upper-limit count each time the number is incremented by 1. The number of escape movable bodies thus does not exceed the first upper-limit count. However, the total number of escape movable bodies is determined after incremented by the number of escape movable bodies for each control target area that is sequentially set. Thus, the total number of escape movable bodies determined in step #8 may exceed the second upper-limit count. When determining that the total number of escape movable bodies is greater than or equal to the second upper-limit count, the controller 2 ends the distribution control. The duration of the distribution control (main process) varies with the total number of escape movable bodies. As described above, the administrator may end the distribution control as appropriate.

When the administrator determines that the concentration of the movable bodies 1 on a specific area E is not fully eliminated after a single cycle of distribution control, the administrator may provide an instruction for the distribution control again.

Other embodiments will now be described. The structures described in the embodiments below may not be implemented separately but may be combined with those in other embodiments unless any contradiction arises.
(1) In the above embodiment, the movable bodies 1 are the ceiling-hung transport vehicles 5 as an example. However, the movable bodies 1 are not limited to the ceiling-hung transport vehicles 5, and may be transport vehicles that travel on the ground (e.g., automatic guided vehicles, or AGVs). In this case, the travelable path 11 is not limited to tracks to be in physical contact with the travel wheels 55 such as travel rails 12 as in the above example. The travelable path 11 may include, for example, a trackless path such as a path defined by magnetic tape, a path defined by walls, and a path defined by coordinates. In other words, the travelable path may be any predetermined path. The trackless path may include a flight path. The movable bodies 1 may include air vehicles such as drones.
(2) In the above embodiment, the areas E are predefined. However, the areas E may be variable. For example, one or more high-density areas F may be set based on the density of movable bodies 1 per unit length on the travelable path 11, and the portion of the travelable path 11 excluding the high-density area(s) F may be divided to define other areas E.
(3) In the above embodiment, the distribution control, or particularly the main process (#3 to #8) in the distribution control, is performed in response to an instruction from the administrator. However, as described above, the preprocess (#1 and #2) in the distribution control may be periodically and automatically performed. In this case, the controller 2 may perform processing equivalent to steps #3 and #4 to determine whether to relocate the movable bodies 1. For example, the controller 2 may determine to relocate the movable bodies 1 when the number of areas E determined to be high-density areas F is larger than a predetermined number or when the movable body density in the high-density area F is higher than or equal to a predetermined value. The controller 2 may thus determine whether to perform the distribution control, or particularly the main process in the distribution control, and perform the distribution control (main process), independently of whether an instruction is provided from the administrator.

An overview of the article transport facility described above is briefly provided below.

In one aspect, an article transport facility includes a plurality of movable bodies each movable along a travelable path to transport an article, and a controller that assigns, to each of the plurality of movable bodies, a task for which a destination is specified and controls the plurality of movable bodies. The travelable path is divided into a plurality of areas. The controller performs, in response to the plurality of areas including a high-density area having a higher density of movable bodies than another area among the plurality of areas, distribution control to change the destination of at least one of the plurality of movable bodies to a escape destination to reduce a density of movable bodies in the high-density area. In the distribution control, the controller sets, in response to a plurality of target movable bodies that are the movable bodies in the high-density area including a transporting movable body transporting the article toward a transfer destination to transfer the article and the transfer destination being outside the high-density area, the escape destination of the transporting movable body to a position inside an area, among the plurality of areas, which area is closer to the transfer destination than the high-density area.

This structure can reduce, through the distribution control, the density of movable bodies in the high-density area and reduce congestion or other factors that interfere with traveling of movable bodies. For the transporting movable body having the transfer destination already determined, the escape destination is set inside another area closer to the transfer destination than the high-density area. This avoids lowering the transport efficiency of the entire facility through the distribution control. The above structure can thus appropriately distribute movable bodies to improve the travel efficiency that may be lowered due to concentration of the movable bodies, and to improve the transport efficiency of the entire facility.

In the article transport facility, in the distribution control, the controller may cancel the task assigned to a movable body, among the plurality of movable bodies which movable body is moving toward a pickup destination to pick up the article.

For the transporting movable body, the escape destination is set inside another area closer to the transfer destination than the high-density area. The transporting movable body may thus limit the improvement in the efficiency of movable body distribution. For a movable body traveling to a pickup destination, in contrast, any movable body carrying no article and close to the pickup destination may be selected after the distribution control. In the distribution control, the task assigned to the pickup-directed movable body may be canceled. This allows the movable body that has been the pickup-directed movable body to be moved to any position independently of its pickup destination. This facilitates appropriate distribution of movable bodies.

In the article transport facility, after the distribution control, the controller may cause the transporting movable body to continue the task and move toward the transfer destination, and reassign a task to a movable body, among the plurality of movable bodies which movable body is other than the transporting movable body.

For the transporting movable body, the escape destination is set inside another area closer to the transfer destination than the high-density area. The transporting movable body can thus promptly transport the article to the transfer destination by continuing the previously assigned task after the distribution control. For a movable body other than the transporting movable body, in contrast, the escape destination may be set to a position independent of the destination associated with the previous task. Thus, the task may be reassigned to each movable body based on its position after the distribution control. This can select any movable body close to the corresponding destination to perform the task. This improves the travel efficiency of movable bodies through the distribution control and also easily improves the transport efficiency after the distribution control.

In the article transport facility, in the distribution control, the controller may preferentially cause a target movable body, among the plurality of target movable bodies which movable body is farther from a center of the high-density area to start moving.

In this structure, a movable body that can more easily move out of the high-density area is preferentially moved in the distribution control. This facilitates the distribution control.

In the article transport facility, the plurality of target movable bodies may include a movable body inside the high-density area and having the destination inside the high-density area, a movable body inside the high-density area and having the destination outside the high-density area, and a movable body inside the high-density area and having no destination for movement.

This structure can appropriately move, out of the high-density area, movable bodies included in the high-density area and associated with the high density in the high-density area.

In the article transport facility, the controller may set, for each of the plurality of areas, an upper-limit count as a maximum number of movable bodies allowed to be in the area. The controller determines, as the high-density area, an area in which a ratio of a target count of movable bodies substantially in the area to the upper-limit count is greater than or equal to a predetermined high-density determination value. The target count for each of the plurality of areas may be a sum of a number of movable bodies inside the area and having the destination inside the area and a number of movable bodies outside the area and having the destination inside the area.

In this structure, the density of movable bodies for each area is determined based on the sum of the number of movable bodies already inside the area and the number of movable bodies highly likely to be inside the area in the immediate future. Thus, the high-density area can be appropriately determined.

What is claimed is:

1. An article transport facility, comprising:
a plurality of movable bodies each movable along a travelable path to transport an article; and
a controller configured to assign, to each of the plurality of movable bodies, a task for which a destination is specified and control the plurality of movable bodies, and
wherein:
the travelable path is divided into a plurality of areas,
the controller is configured to perform, in response to the plurality of areas comprising a high-density area having a higher density of movable bodies than another area among the plurality of areas, distribution control to change the destination of at least one of the plurality of movable bodies to an escape destination to reduce a density of movable bodies in the high-density area, and
in the distribution control, the controller is configured to set, in response to a plurality of target movable bodies that are the movable bodies in the high-density area comprising a transporting movable body transporting the article toward a transfer destination to transfer the article and the transfer destination being outside the high-density area, the escape destination of the transporting movable body to a position inside an area, among the plurality of areas, which area is closer to the transfer destination than the high-density area.

2. The article transport facility according to claim 1, wherein:
in the distribution control, the controller cancels the task assigned to a movable body, among the plurality of movable bodies which movable body is moving toward a pickup destination to pick up the article.

3. The article transport facility according to claim 1, wherein:
after the distribution control, the controller causes the transporting movable body to continue the task and move toward the transfer destination, and reassigns a task to a movable body, among the plurality of movable bodies which movable body is other than the transporting movable body.

4. The article transport facility according to claim 1, wherein:
in the distribution control, the controller preferentially causes a target movable body, among the plurality of target movable bodies which movable body is farther from a center of the high-density area to start moving.

5. The article transport facility according to claim 1, wherein:
the plurality of target movable bodies comprise:
a movable body inside the high-density area and having the destination inside the high-density area,
a movable body inside the high-density area and having the destination outside the high-density area, and
a movable body inside the high-density area and having no destination for movement.

6. The article transport facility according to claim 1, wherein:
the controller sets, for each of the plurality of areas, an upper-limit count as a maximum number of movable bodies allowed to be in the area,
the controller determines, as the high-density area, an area in which a ratio of a target count of movable bodies substantially in the area to the upper-limit count is greater than or equal to a predetermined high-density determination value, and
the target count for each of the plurality of areas is a sum of a number of movable bodies inside the area and having the destination inside the area and a number of movable bodies outside the area and having the destination inside the area.
